(19) United States
(12) Patent Application Publication
(10) Pub. No.: US 2014/0042179 A1
(43) Pub. Date: Feb. 13, 2014

(54) AUTOMATIC VENDING MACHINE WITH MOVING MEMBER FOR PRODUCTS

(71) Applicants: YUN-LUNG CHEN, Tu-Cheng (TW); CHUNG CHAI, Tu-Cheng (TW); DA-LONG SUN, Wuhan City (CN); SHENG-HE LI, Wuhan City (CN)

(72) Inventors: YUN-LUNG CHEN, Tu-Cheng (TW); CHUNG CHAI, Tu-Cheng (TW); DA-LONG SUN, Wuhan City (CN); SHENG-HE LI, Wuhan City (CN)

(73) Assignees: HON HAI PRECISION INDUSTRY CO., LTD., Tu-Cheng (TW); HONG FU JIN PRECISION INDUSTRY (WUHAN) CO., LTD., Wuhan City (CN)

(21) Appl. No.: 13/616,296

(22) Filed: Sep. 14, 2012

(30) Foreign Application Priority Data
Aug. 13, 2012 (CN) 2012102858751

(51) Int. Cl. B65G 33/04

(52) U.S. Cl. 221/258

(57) ABSTRACT

An automatic vending machine includes a chassis and a moving mechanism. The chassis defines a channel configured for receiving products. The moving mechanism is attached to the chassis and includes a moving member, a driving assembly, and a mounting member. The moving member is received in the channel and configured for moving the products. The mounting member is secured to the driving assembly and is rotated by the driving assembly. The mounting member defines a plurality of mounting slots. The moving member is located in different positions relative to the mounting member when engaged in different mounting slots.

### BACKGROUND

1. Technical Field

The present disclosure relates to automatic vending machines, and more particularly to an automatic vending machine with a moving member for moving products.

2. Description of Related Art

In an automatic vending machine, a helical coil is rotated by a motor to transmit products. However, the helical coil is usually fixed with the motor and cannot be rotated relative to the motor, which is very inconvenient when new products, particularly with different sizes, are to be added.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric, cutaway view of one embodiment of an automatic vending machine.

FIG. 2 is an exploded, isometric, cutaway view of a side plate and a moving mechanism of the automatic vending machine of FIG. 1.

FIG. 3 is similar to FIG. 2, but viewed from a different aspect.

FIG. 4 is an isometric view of a mounting member of the moving mechanism of FIG. 2.

FIG. 5 is an isometric view of a locking member of the moving mechanism of FIG. 3.

FIG. 6 is an assembled, cutaway view of the automatic vending machine of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one”.

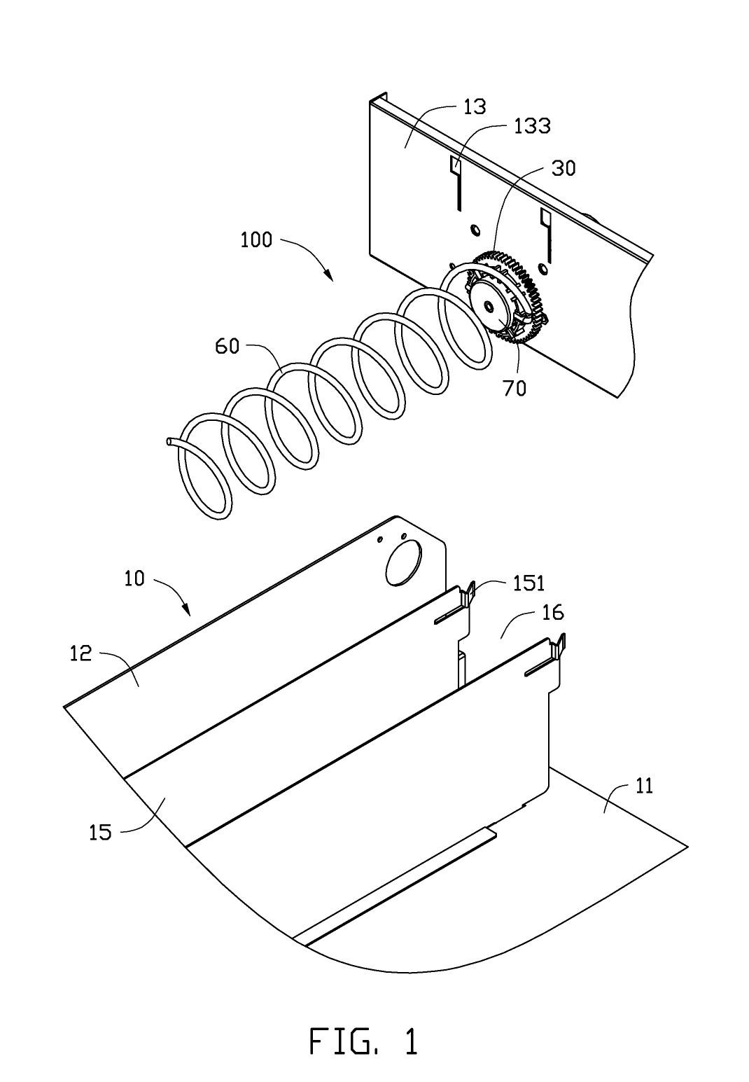

FIGS. 1-3 illustrate one embodiment of an automatic vending machine comprising a chassis 10 and a moving mechanism 100 attached to the chassis 10.

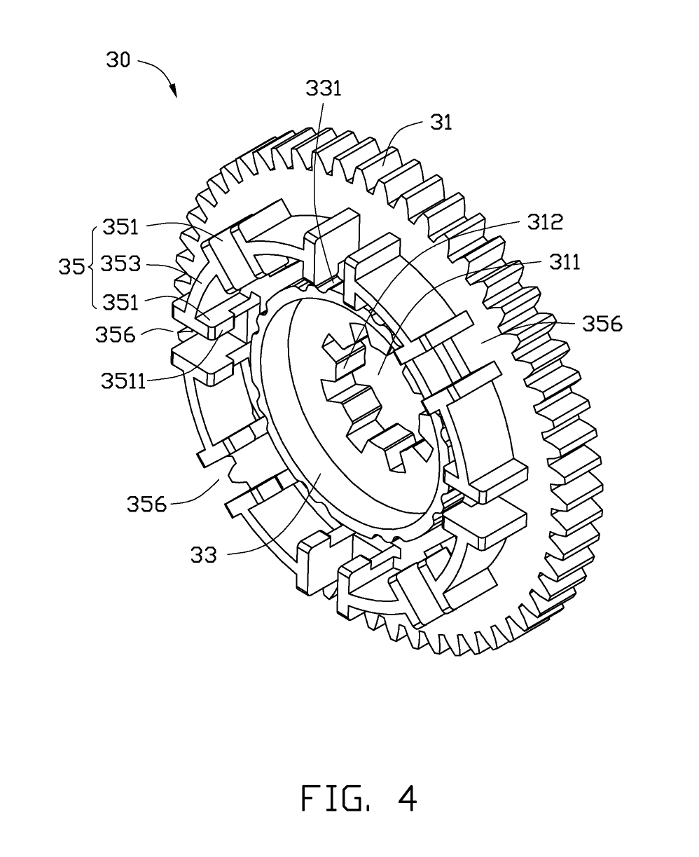

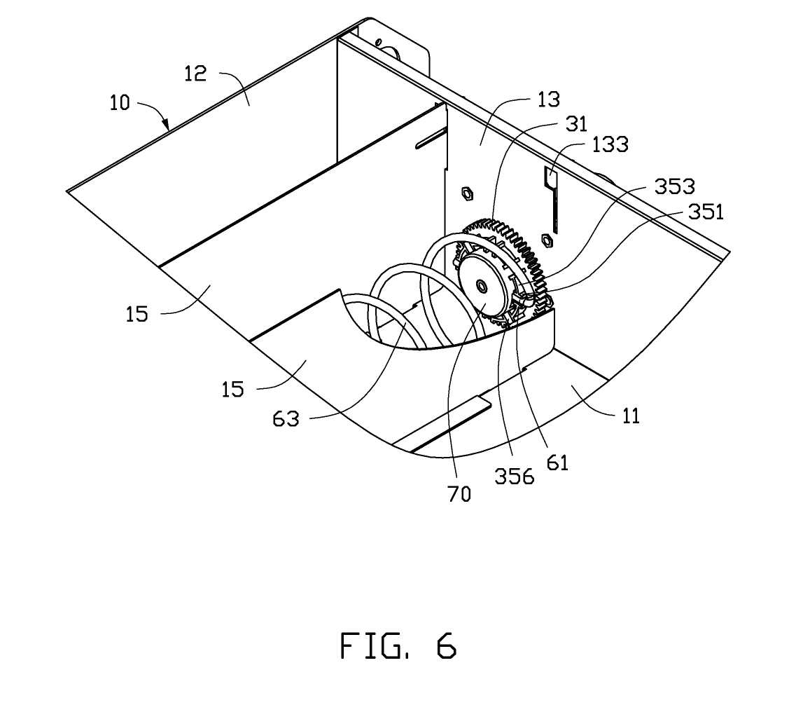

The chassis 10 defines a channel 16 configured for receiving products (not shown). The moving mechanism 100 comprises a moving member 60, a driving assembly 50, and a mounting member 30. Referring to FIG. 6, the moving member 60 is received in the channel 16, and the mounting member 30 is secured to the driving assembly 50 and rotatable when driven by the driving assembly 50. Referring to FIG. 4, the mounting member 30 defines a plurality of mounting slots 356. The moving member 60 is located in different positions relative to the mounting member 30 when engaged with different mounting slots 356.

The chassis 10 comprises a side plate 13, and the moving mechanism 100 is secured to the side plate 13. The side plate 13 defines a through hole 131. The driving assembly 50 comprises a driving member 53, which comprises a motor 531. The mounting member 30 is secured to the motor 531 via the through hole 131 and is capable of being rotated by the motor 531.

The driving assembly 50 further comprises a connecting member 51 secured to the mounting member 51 and the motor 531. The connecting member 51 is located in the through hole and is capable of being rotated by the motor 531.

The driving member 53 further comprises a case 532 secured to the side plate 13 and a latch 533 secured to the motor 531. The motor 531 is secured to the case 532. The latch 533 is capable of being rotated by the motor 531, and the connecting member 510 is secured to the latch 533. In the embodiment, the connecting member 51 and the latch 533 act as a medium to transmit torque from the motor 531 to the mounting member 30. The mounting member 30 can also be secured directly to the motor directly by well-known means, such as screws.

The mounting member 30 comprises a plurality of internal teeth 312. The connecting member 51 comprises a plurality of peripheral gear teeth 511, which mesh with the internal teeth gear teeth 312 of the mounting member 30.

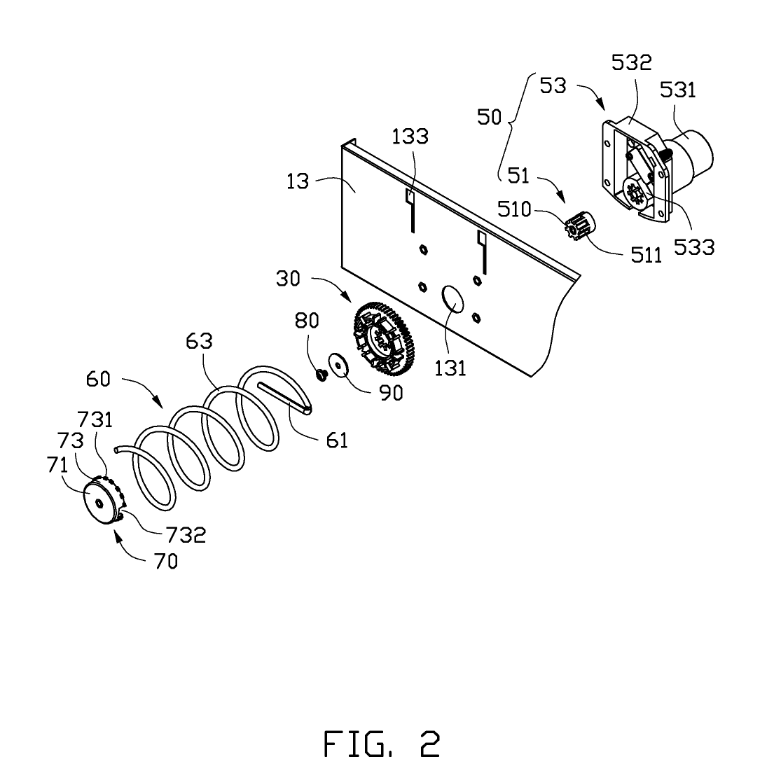

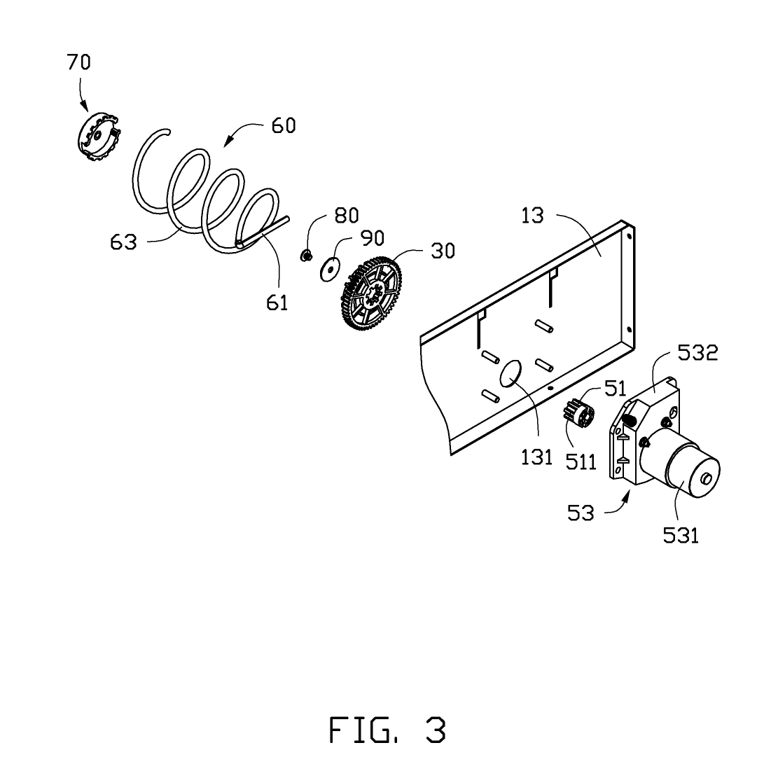

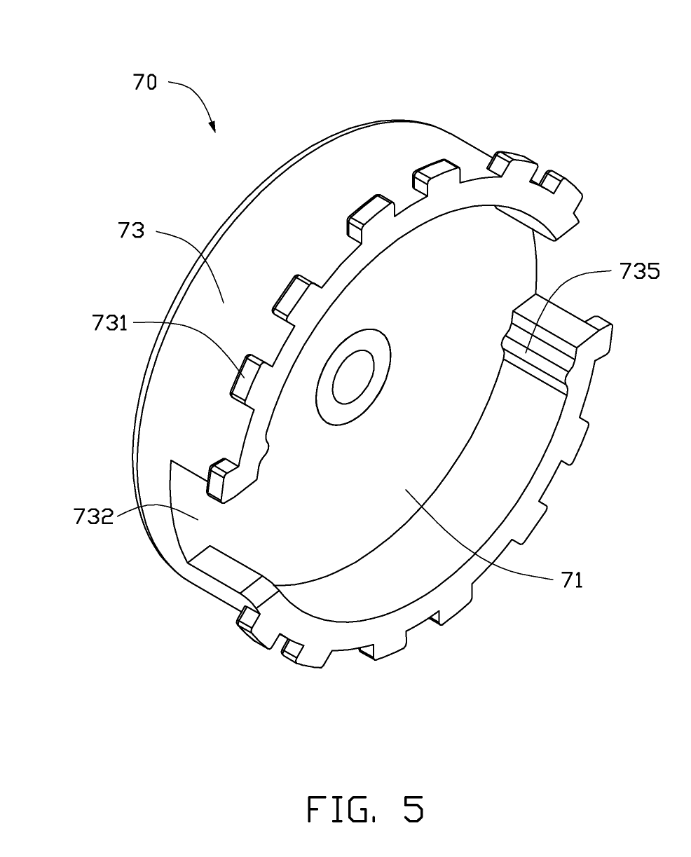

The moving mechanism 50 further comprises a locking member 70 secured to the mounting member 30 which prevents the moving member 60 from disengaging from the mounting member 30. The locking member 70 comprises a plurality of securing tabs 731 (shown in FIG. 5), and the mounting member 30 comprises a plurality of securing blocks 3511 (shown in FIG. 4). The plurality of securing tabs 731 is engaged with the plurality of securing blocks 3511 to secure the locking member 70 to the mounting member 30. In one embodiment, the mounting member defines a mounting hole 311, and the internal teeth 312 are arranged around the mounting hole 311, the connecting member 51 defines a fixing hole 510, a washer 90 (shown in FIGS. 2-3) is placed on the mounting member 30, and a fastener 80 (shown in FIGS. 2 and 3) is inserted through the washer 90 and the through hole 131 to engage in the fixing hole 510 to secure the mounting member 30 to the connecting member 51.

Referring to FIGS. 4 and 5, the locking member 70 further comprises a positioning protrusion 735, and the mounting member 30 further comprises a plurality of concave portions 331. The locking member 70 is located in different positions when the positioning protrusion 735 is engaged in different concave portions 331. The mounting member 30 further comprises a first mounting structure 35 and a second mounting structure 33 surrounded by the first mounting structure 35. The locking member 70 further comprises a flange 73. Referring to FIG. 6, the flange 73 is secured between the first mounting structure 35 and the second mounting structure 33, and is configured to twist about the second mounting structure 33. In one embodiment, the mounting hole 31 is surrounded by the second mounting structure 33. The plurality of securing tabs 731, an outer surface of the flange 73, and the positioning protrusion 735 are located on an inner surface of the flange 73. The plurality of securing blocks 3511 are located on the first mounting structure 35. The plurality of mounting slots 356 are defined in the first mounting structure 35, and the plurality of concave portions 331 are located on the second mounting structure 33. The flange 73 of the locking member 70 defines a cutout 732, and an end of the moving member 60 is engaged in the cutout 732 (shown in FIG. 6) and located between the locking member 70 and the mounting member 30. The locking member 70 further comprises a base 71, and the flange 73 substantially perpendicularly extends from the base 71.

Referring to FIG. 4, the first mounting structure 35 comprises a plurality of arc walls 353 and a plurality of positioning walls 351. The plurality of arc walls 353 are arranged in a broken circle, and two of the plurality of positioning walls 351 are secured to each of the plurality of arc walls 353. The securing block 3511 is located on each of the plurality of positioning walls 351.

Referring to FIGS. 1-3, the chassis 10 further comprises two separated plates 15 substantially parallel to each other and perpendicular to the side plate 13. The channel 16 is defined between the two separated plates 15, and the two separated plates 15 are secured to the side plate 13. A locking piece 151 is located on each of the two separated plates 15. Two locking holes 133 are defined in the side plate 13. Referring to FIG. 6, the two locking holes 133 receive the locking pieces 151 of the two separated plates 15. When the locking pieces 151 of the two separated plates 15 are resiliently deformed to disengage from the two locking holes 133, the side plate 13 can be removed from the two separated plates 15. The chassis 10 further comprises a bottom plate 11. The two separated plates 15 and the side plate 13 are substantially perpendicularly located on the bottom plate 11.

When the motor 531 works to rotate the connecting member 51 and the mounting member 30, the moving member 60 is rotated and pushes products along the channel 16. The moving member 60 comprises a plurality of spiral portions 63, and a product can be located between two adjacent spiral portions 63. In one embodiment, the moving member 60 is a helical coil, the plurality of spiral portions 63 are active windings used to push the products to slide in the channel 16.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. An automatic vending machine comprising:
a chassis defining a channel configured for receiving products; and
a moving mechanism attached to the chassis, the moving mechanism comprising a moving member, a driving assembly, and a mounting member, wherein the moving member is received in the channel and configured for moving the products, the mounting member is secured to the driving assembly and rotated when driven by the driving assembly, the mounting member defines a plurality of mounting slots, and the moving member is located in different positions relative to the mounting member when engaged in different mounting slots.

2. The automatic vending machine of claim 1, wherein the chassis comprises a side plate, and the moving mechanism is secured to the side plate.

3. The automatic vending machine of claim 2, wherein the side plate defines a through hole, the driving assembly comprises a driving member, the driving member comprises a motor, and the mounting member is secured to the motor via the through hole and is capable of being rotated by the motor.

4. The automatic vending machine of claim 3, wherein the driving assembly further comprises a connecting member connected to the mounting member and the motor, the connecting member is capable of being rotated by the motor, and the connecting member is located in the through hole.

5. The automatic vending machine of claim 4, wherein the driving member further comprises a case secured to the side plate and a latch secured to the motor, the motor is secured to the case, the latch is capable of being rotated by the motor, and the connecting member is secured to the latch.

6. The automatic vending machine of claim 1, wherein the moving mechanism further comprises a locking member secured to the mounting member to prevent the moving member from disengaging from the mounting member.

7. The automatic vending machine of claim 6, wherein the locking member comprises a plurality of securing tabs, the mounting member comprises a plurality of securing blocks, and the plurality of securing tabs is engaged with the plurality of securing blocks to secure the locking member to the mounting member.

8. The automatic vending machine of claim 7, wherein the locking member further comprises a positioning protrusion, the mounting member further comprises a plurality of concave portions, and the locking member is located in different positions when the positioning protrusion is respectively engaged in the plurality of concave portions.

9. The automatic vending machine of claim 8, wherein the mounting member further comprises a first mounting structure and a second mounting structure surrounded by the first mounting structure, and the locking member further comprises a flange secured between the first mounting structure and the second mounting structure.

10. The automatic vending machine of claim 9, wherein the plurality of securing tabs are located on the flange, the plurality of securing blocks are located on the first mounting structure, the plurality of mounting slots are defined in the first mounting structure, and the plurality of concave portions are located on the second mounting structure.

11. The automatic vending machine of claim 9, wherein the flange of the locking member defines a cutout, and an end of the moving member is engaged in the cutout and located between the locking member and the mounting member.

12. The automatic vending machine of claim 2, wherein the chassis further comprises two separated plates substantially parallel to each other and perpendicular to the side plate, the channel is defined between the two separated plates, and the two separated plates are secured to the side plate.

13. The automatic vending machine of claim 12, wherein a locking piece is located on each of the two separated plates, two locking holes are defined in the side plate, the two locking holes receive the locking pieces of the two separated plates, and the locking pieces of the two separated plates are resiliently deformable to disengage from the two locking holes.

14. An automatic vending machine comprising:
a chassis defining a channel configured for receiving a plurality of products; and
a moving mechanism attached to the chassis, the moving mechanism comprising a moving member, a driving assembly, and a mounting member, wherein the moving member is received in the channel and comprises a plurality of spiral portions, each adjacent two of the plurality of spiral portions is configured to receive one of the plurality of products, the mounting member is secured to the driving assembly, the mounting member defines a plurality of mounting slots, and the moving member is alternately located engaged in one the plurality of mounting slots;
wherein when the mounting member is rotated by the driving assembly, the moving member is rotated by the mounting member, and the plurality of spiral portions push the plurality of product to slide in the channel.

15. The automatic vending machine of claim 14, wherein the chassis comprises a side plate, and the moving mechanism is secured to the side plate.

16. The automatic vending machine of claim 15, wherein the side plate defines a through hole, the driving assembly comprises a driving member, the driving member comprises a motor, and the mounting member is secured to the motor via the through hole and is capable of being rotated by the motor.

17. The automatic vending machine of claim 16, wherein the driving assembly further comprises a connecting member connected to the mounting member and the motor, the connecting member is capable of being rotated by the motor, and the connecting member is located in the through hole.

18. The automatic vending machine of claim 17, wherein the driving member further comprises a case secured to the side plate and a latch secured to the motor, the motor is secured to the case, the latch is capable of being rotated by the motor, and the connecting member is secured to the latch.

19. The automatic vending machine of claim 14, wherein the moving mechanism further comprises a locking member secured to the mounting member to prevent the moving member from disengaging from the mounting member, the locking member comprises a plurality of securing tabs, and the mounting member comprises a plurality of securing blocks, and the plurality of securing tabs is engaged with the plurality of securing blocks to secure the locking member to the mounting member.

20. The automatic vending machine of claim 19, wherein the locking member further comprises a positioning protrusion, and the mounting member further comprises a plurality of concave portions, and the locking member is engaged in one of the plurality of concave portions.
